(19) United States
(12) Patent Application Publication
(10) Pub. No.: US 2010/0049823 A1
(43) Pub. Date: Feb. 25, 2010

(54) Initial copyless remote copy

(76) Inventors: Kiyokazu Saigo, San Jose, CA (US); Tomohiro Kawaguchi, Cupertino, CA (US)

Correspondence Address: MATTINGLY & MALUR, P.C., 1800 DIAGONAL ROAD, SUITE 370, ALEXANDRIA, VA, 22314, US

(21) Appl. No.: 12/222,976

(22) Filed: Aug. 21, 2008

(51) Int. Cl. G06F 15/167

(52) U.S. Cl. 709/216

(57) ABSTRACT

Embodiments of the invention reduce the traffic between datacenters during initial remote copy. In one embodiment, a computer system comprises a first datacenter including a first source volume and a second datacenter including a second source volume. Prior to establishment of remote copy of deployed volumes between the first datacenter and the second datacenter, the first source volume of the first datacenter and the second source volume of the second datacenter have identical source objects. During establishment of remote copy, the first datacenter replicates the source object in the first source volume to a first target volume, the second datacenter replicates the source object in the second source volume to a second target volume, and a first replicated object in the first target volume and a second replicated object in the second target volume are related to each other by remote copy with no copying therebetween.

### BACKGROUND OF THE INVENTION

The present invention relates generally to remote copy in storage systems and, more particularly, to methods and apparatus for initial copyless remote copy.

The virtualization technology continues to develop and much progress has been made. In one aspect, storage system administrators manage the “Object Manager” to provision the virtualized environment. That is, they prepare the objects which contain OS/Applications/Libraries in advance, and copy them to the storage to start services with the virtualized environment. Many storage servers are consolidated, and large scale datacenters are built. The disaster recovery system which mirrors data between this large scale datacenters is structured.

The remote copy function in a storage system supports synchronous or asynchronous I/O replication between volumes of local and remote storage subsystems. Asynchronous remote copy function can maintain the consistency of I/O order. When a shutdown or some other failure occurs at the local storage subsystem, the remote storage subsystem takes over the data in a failover process. During failover, the remote storage subsystem will be accessed to continue processing data. After the local storage is repaired, the local storage is restored using data from the remote storage subsystem in a failback process.

Peer-to-Peer Remote Copy (PPRC) is an Enterprise Storage Server (ESS) function that allows the shadowing of application system data from one site (usually called the application site) to a second site (called the recovery site). The logical volumes that hold the data in the ESS at the application site are called primary volumes, and the corresponding logical volumes that hold the mirrored data at the recovery site are called secondary volumes.

When this function is installed, there are three different ways of using it. First, the synchronous operation (PPRC-SYNC) synchronously mirrors the updates done to the primary volumes. This can be used in distances of up to 103 km (an RPQ has to be submitted if slighter longer distances need to be implemented). Second, the synchronous operation using primary static volumes can be used to move or copy data at very long distances using channel extenders. Third, the extended distance operation (PPRC-XD) operates non-synchronously and can be used over continental distances, with excellent application performance. When implementing this solution over long distances, channel extenders are required.

The PPRC can have four different statuses. First, “Simplex” is the initial state of a volume. A PPRC volume pair relationship has not been established yet between the primary and the secondary volumes. Second, “Pending” is the initial state of a defined PPRC-SYNC volume pair relationship, when the initial copy of the primary volume to the secondary volume is happening. This status also is found when a PPRC-SYNC volume pair is re-synchronized after it was suspended. During the pending period, the volume pair is not in synchronization and PPRC is copying tracks from the primary to the secondary volume. Third, “Duplex” is the status of a PPRC-SYNC volume pair after the PPRC has fully completed the copy operation of the primary volume onto the secondary volume. At this moment, the volume pair is in synchronization and all write updates to the primary volume are synchronously applied onto the secondary volume. Fourth, “Suspended” is a status of the PPRC pair in which the writes to the primary volume are not mirrored onto the secondary volume. The secondary volume becomes out of synchronization. During this time, the PPRC keeps a bit map record of the changed tracks in the primary volume. Later, when the volumes are re-synchronized, only the tracks that were updated will be copied. As used herein, the “Pending” status is written as COPY status, the “Duplex” status is written as PAIR status, and the “Suspended” status is written SPLIT status.

The following describes how PPRC-SYNC can be used over long distances. At initial copy, the PPRC does a pass across the volume copying all the tracks. A second pass is done copying just the updated tracks that were checked in the bit-map. Now the volume pair is in full duplex mode and all the write updates are mirrored synchronously.

In a typical remote copy procedure, one volume (Volume A) is main volume, and the other (Volume B) is a sub volume. At first, the two volumes have different data (SIMPLEX). All the Volume A data is transferred to Volume B (COPY, especially INITIAL COPY). The status changes to PAIR, which means I/O information to Volume A is transferred to Volume B immediately (PAIR). If the administrator intends to ensure that Volume B has the mirrored Volume A data at given times, the SPLIT operation is executed (SPLIT).

In the sequence of “Remote copy”, a lot of data is transferred between storage source volumes and target volumes to produce heavy traffic. Thus, a lot of data is transferred between datacenters. Each datacenter has become to possess a lot of data volumes, so the data traffic described above has increased. Especially the data traffic during the status “INITIAL COPY” has increased in proportion to the total data volume size of the datacenter. This increase in data traffic requires an increased bandwidth between datacenters, thereby increasing the cost. If the bandwidth between datacenters is not high enough, it requires much time to complete the data transfer, especially to complete INITIAL COPY. This delays the time to start services, because administrators cannot start service until INITIAL COPY is completed.

### BRIEF SUMMARY OF THE INVENTION

Embodiments of the invention provide methods and apparatus for reducing the traffic between datacenters and reducing cost during initial remote copy. This is achieved by reducing INITIAL COPY traffic data. To reduce the traffic, both of the main datacenter and the sub datacenter possess the same virtualized object (Source Object) which contains OS/Applications/Libraries. The Source Objects (Main Source Object and Sub Source Object) are managed by “Remote copy”. The status is usually SPLIT. The Main Source Object of the main datacenter does not change, so the Sub Source Object of the sub datacenter is the same. When the manager provisions, the Main Source Object is replicated to the volume of the main datacenter and the Sub Source Object is replicated to the volume of the sub datacenter. After the completion of the provisioning, the replicated Main Source Object and the replicated Sub Source Object connect to each other with remote copy. The remote copy status starts at “PAIR” with “NOCOPY”.

Previously when two volumes connect to each other with remote copy, the status starts at “COPY (INITIAL COPY)”, and this requires a lot of traffic to change the status to “PAIR”. By omitting this initial copy, traffic is reduced.

In accordance with an aspect of the present invention, a computer system comprises a first datacenter having at least one computer device connected to at least one storage device via a first datacenter network, the at least one storage device including a first source volume; and a second datacenter having at least one computer device connected to at least one storage device via a second datacenter network, the at least one storage device including a second source volume. The first datacenter and the second datacenter are connected via a network. Prior to establishment of remote copy of deployed volumes between the first datacenter and the second datacenter, the first source volume of the first datacenter and the second source volume of the second datacenter have identical source objects. During establishment of remote copy of deployed volumes between the first datacenter and the second datacenter, the first datacenter replicates the source object in the first source volume to a first target volume, the second datacenter replicates the source object in the second source volume to a second target volume, and a first replicated object in the first target volume of the first datacenter and a second replicated object in the second target volume of the second datacenter are related to each other by remote copy with no copying therebetween.

In some embodiments, the source object in the first source volume of the first datacenter and the source object in the second source volume of the second datacenter are related by remote copy at SPLIT status. The first replicated object in the first target volume of the first datacenter and the second replicated object in the second target volume of the second datacenter are related by remote copy at PAIR with NOCOPY status.

Prior to establishment of remote copy of deployed volumes between the first datacenter and the second datacenter, the identical source objects are virtualized source objects that are installed and upgraded simultaneously in the first source volume of the first datacenter and the second source volume of the second datacenter in a first embodiment. In a second embodiment, the source object is a virtualized source object that is installed in the first source volume of the first datacenter and is then replicated from the first source volume of the first datacenter to the second source volume of the second datacenter, and the source object is upgraded in the first source volume of the first datacenter and is then replicated from the first source volume of the first datacenter to the second source volume of the second datacenter. In a third embodiment, the source objects are virtualized source objects that are installed and upgraded in the first source volume of the first datacenter and the second source volume of the second datacenter, and the upgraded objects do not overwrite the installed objects.

In specific embodiments, the computer system further comprises a third datacenter having at least one computer device connected to at least one storage device via a third datacenter network, the at least one storage device including a third source volume. The first datacenter, the second datacenter, and the third datacenter are connected via the network. Prior to establishment of remote copy of deployed volumes between the first datacenter and the third datacenter, the first source volume of the first datacenter and the third source volume of the third datacenter have identical source objects. During establishment of remote copy of deployed volumes between the first datacenter and the third datacenter, the first datacenter replicates the source object in the first source volume to the first target volume, the third datacenter replicates the source object in the third volume to a third target volume, and the first replicated object in the first target volume of the first datacenter and a third replicated object in the third target volume of the third datacenter are related to each other by remote copy with no copying therebetween.

In accordance with another aspect of the invention, a computer system comprises a first datacenter having at least one computer device connected to at least one storage device via a first datacenter network, the at least one storage device including a first source volume; a second datacenter having at least one computer device connected to at least one storage device via a second datacenter network, the at least one storage device including a second source volume; and a management computer connected to the first datacenter and the second datacenter via a network. Prior to establishment of remote copy of deployed volumes between the first datacenter and the second datacenter, the first source volume of the first datacenter and the second source volume of the second datacenter have identical source objects. During establishment of remote copy of deployed volumes between the first datacenter and the second datacenter, the management computer is configured to order the first datacenter to replicate the source object in the first source volume to a first target volume and to order the second datacenter to replicate the source object in the second source volume to a second target volume, and to establish remote copy with no copying between a first replicated object in the first target volume of the first datacenter and a second replicated object in the second target volume of the second datacenter.

In some embodiments, after the first datacenter replicates the source object in the first source volume to the first target volume and the second datacenter replicates the source object in the second source volume to the second target volume, the management computer automatically relates the first replicated object in the first target volume of the first datacenter and the second replicated object in the second target volume of the second datacenter by remote copy and sets the remote copy at PAIR with NOCOPY status. Prior to establishment of remote copy of deployed volumes between the first datacenter and the second datacenter, the management computer is configured to instruct the first datacenter and the second datacenter to install and upgrade the identical source objects, which are virtualized source objects, in the first source volume of the first datacenter and the second source volume of the second datacenter. The management computer is configured to calculate hash values of the first target volume of the first datacenter and the second target volume of the second datacenter, and to compare the hash values to ascertain that the first target volume and the second target volume have the same objects.

In specific embodiments, the computer system further comprises at least one additional datacenter each having at least one computer device connected to at least one storage device via an additional datacenter network, the at least one storage device including an additional source volume. The first datacenter, the second datacenter, and the at least one additional datacenter are connected via the network. Prior to establishment of remote copy of deployed volumes between the first datacenter and the at least one additional datacenter, the first source volume of the first datacenter and the additional source volume of each of the at least one additional datacenter have identical source objects. During establishment of remote copy of deployed volumes between the first datacenter and the at least one additional datacenter, the first datacenter replicates the source object in the first source volume to the first target volume, each of the at least one additional datacenter replicates the source object in the additional volume to an additional target volume, and the first replicated object in the first target volume of the first datacenter and an additional replicated object in the additional target volume of each of the at least one additional datacenter are related to each other by remote copy with no copying therebetween.

Another aspect of the invention is directed to a computer system which includes a first datacenter having at least one computer device connected to at least one storage device via a first datacenter network, the at least one storage device including a first source volume; and a second datacenter having at least one computer device connected to at least one storage device via a second datacenter network, the at least one storage device including a second source volume. The first datacenter and the second datacenter are connected via a network. The first source volume of the first datacenter and the second source volume of the second datacenter having identical source objects. A method of establishing copyless remote copy comprises ordering the first datacenter to replicate the source object in the first source volume to a first target volume; ordering the second datacenter to replicate the source object in the second source volume to a second target volume; and establishing remote copy with no copying between a first replicated object in the first target volume of the first datacenter and a second replicated object in the second target volume of the second datacenter.

These and other features and advantages of the present invention will become apparent to those of ordinary skill in the art in view of the following detailed description of the specific embodiments.

### BRIEF DESCRIPTION OF THE DRAWINGS

FIG. 1 illustrates an example of a hardware configuration of a storage subsystem in which the method and apparatus of the invention may be applied.

FIG. 2 illustrates an exemplary physical and logical system configuration of a datacenter.

FIG. 3 illustrates an exemplary physical and logical system configuration involving two datacenters according to one aspect of the invention.

FIG. 4 illustrates the preparation and management of the virtualized objects according to a first embodiment of the invention.

FIG. 5 illustrates the preparation and management of the virtualized objects according to a second embodiment of the invention.

FIG. 6 illustrates the preparation and management of the virtualized objects according to a third embodiment of the invention.

FIG. 7 illustrates an example of the deployment interface.

FIG. 8 illustrates an example of the volume management table for the two datacenter model of FIG. 3.

FIG. 9 illustrates an example of the remote copy management table.

FIG. 10 illustrates an example of the local copy management table.

FIG. 11 illustrates an example of the usage of the virtualized object by the general server.

FIG. 12 illustrates an exemplary physical and logical system configuration involving three datacenters according to another aspect of the invention.

FIG. 13 illustrates the preparation and management of the virtualized objects for the three datacenter model of FIG. 12 according to one embodiment of the invention.

FIG. 14 illustrates an example of the usage of the virtualized object by the general server for the three datacenter model of FIG. 12.

FIG. 15 illustrates an example of the volume management table for the three datacenter model of FIG. 12.

FIG. 16 illustrates another example of the usage of the virtualized object by the general server.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment”, “this embodiment”, or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Exemplary embodiments of the invention, as will be described in greater detail below, provide apparatuses, methods and computer programs for initial copyless remote copy to reduce data traffic.

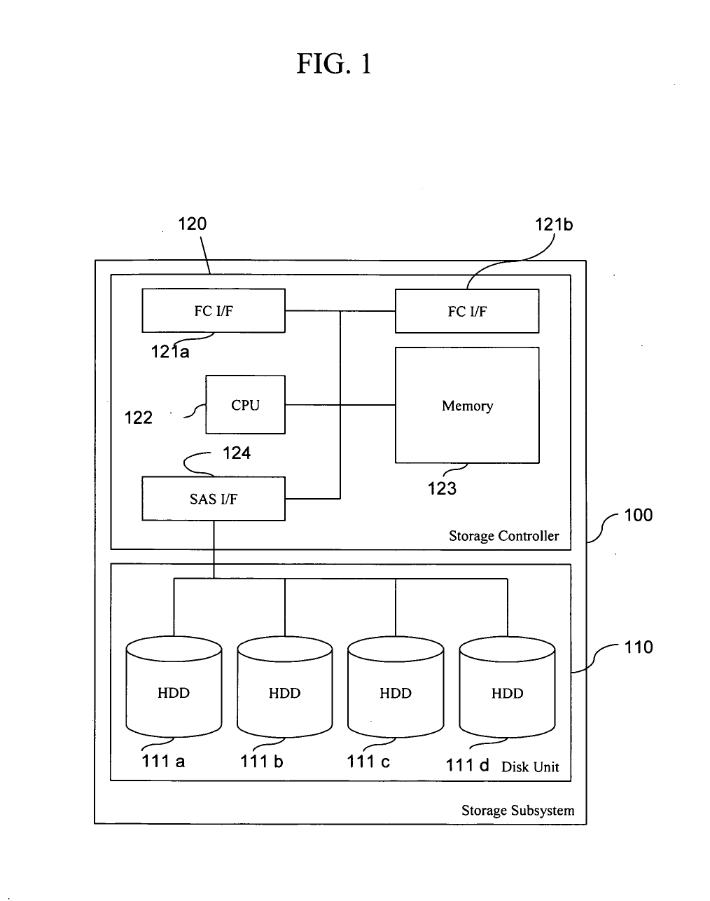

FIG. 1 illustrates an example of a hardware configuration of a storage subsystem 100 in which the method and apparatus of the invention may be applied. The storage subsystem 100 has a disk unit 110 and a storage controller 120. The storage subsystem 100 may have one or more disk units 100 and one or more storage controllers 120. The disk unit 110 has one or more HDDs. FIG. 1 shows four HDDs 111a, 111b, 111c, 111d. The storage controller 120 has a fiber channel interface or FC I/F 121, a CPU 122, a memory 123, and an SAS I/F 124. The FC I/F 121 is linked to a network or to another storage subsystem. There may be one or more FC I/Fs, and FIG. 1 shows two FC I/Fs 121a, 121b. This interface can be of a type other than fiber channel. The CPU 122 runs programs that are stored in the memory 123. The memory 123 stores storage control programs, tables and cache data. The SAS interface 124 is linked to the disks 111a, 111b, 111c, and 111d. This interface can be of a type other than SAS.

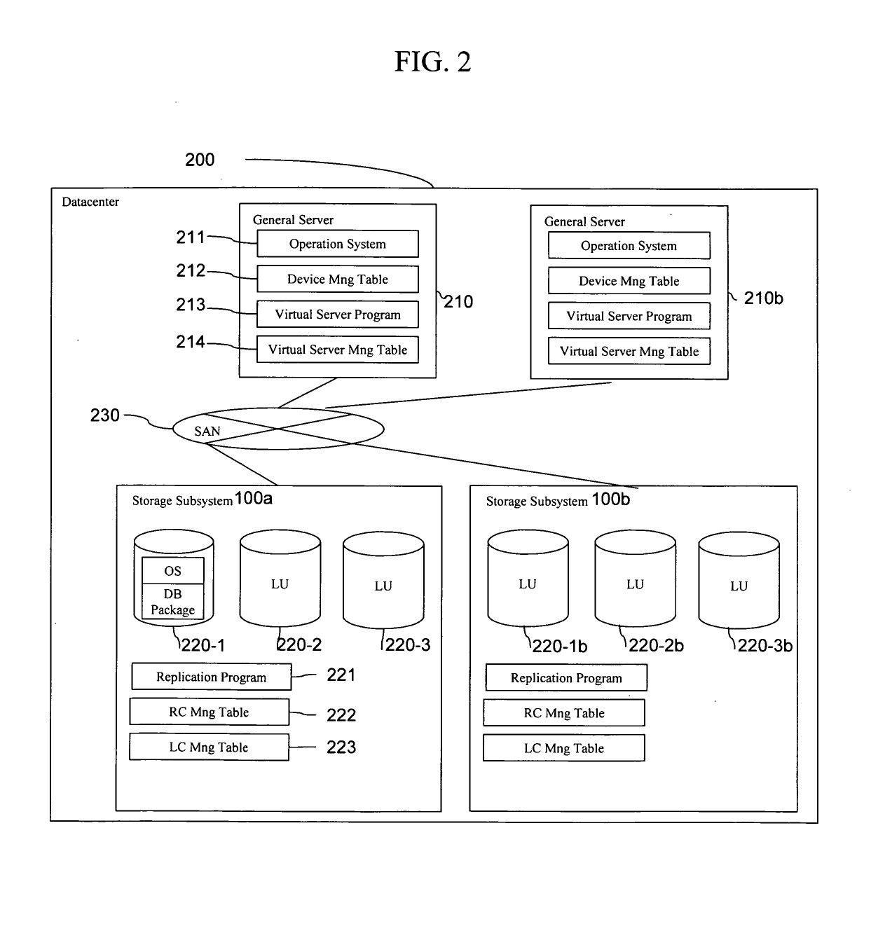

FIG. 2 illustrates an exemplary physical and logical system configuration of a datacenter 200. The datacenter 200 has one or more general servers that are connected via a network 230. FIG. 2 shows two general servers 210, 210b connected via a storage area network (SAN) 230. Each general server 210, 210b has an operating system 211, a device management table 212, a virtual server program 213, and a virtual server management table 214. The operating system 211 is a software component of a system that is responsible for the management and coordination of activities and the sharing of the resources of the computer. The device management table 212 stores device information which the general server 210 uses. The virtual server program 213 splits and/or consolidates resources of the general server 210 and it can virtually run one or more servers in the general server 210. A bootable image of the virtual server is stored in the storage subsystem 100a. The virtual server management table 214 manages the relationship between the virtual server and the corresponding physical device in the general server 210.

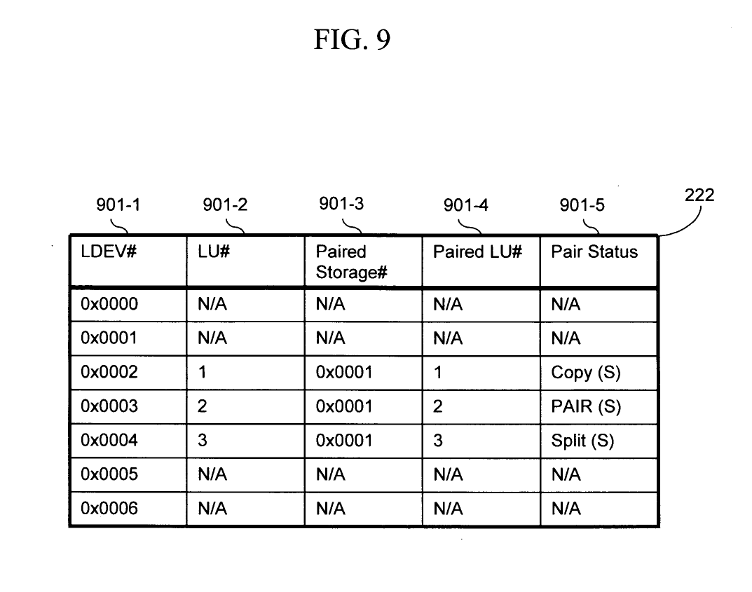

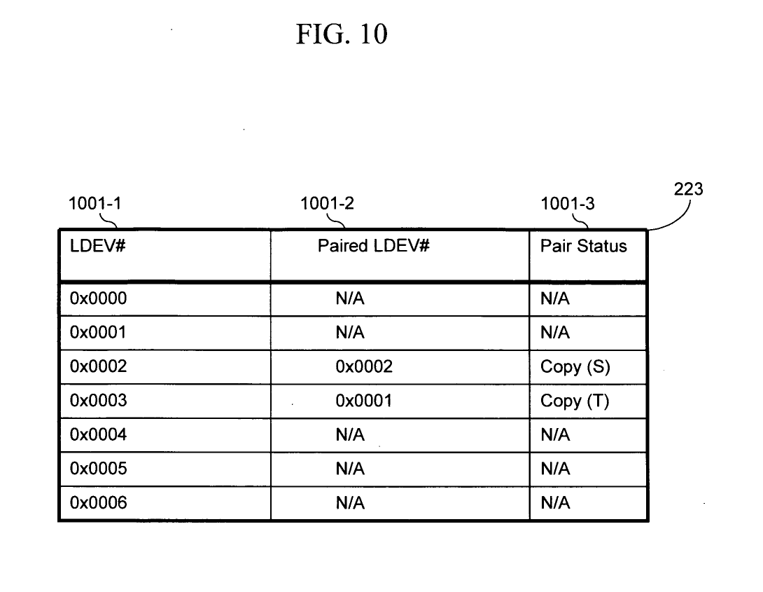

Two storage subsystems 100a, 100b are connected to the SAN 230. The system configuration of storage subsystems is described in FIG. 1. Each storage subsystem has one or more LU (logical unit or volumes) and one or more programs, and tables. As seen in FIG. 2, the storage subsystem 100a has three LUs (220-1, 220-2, 220-3). LU 220-1 is shown as including database (DB) packages. Others are shown as being empty. The replication program 221 is a program that replicates data from one volume to another. The remote copy management table 222 is a table that manages the source-target information of remote copy. The remote copy management table 222 is described in connection with FIG. 9. The local copy management table 223 is a table that manages the source-target information of local copy. The local copy management table 223 is described in connection with FIG. 10.

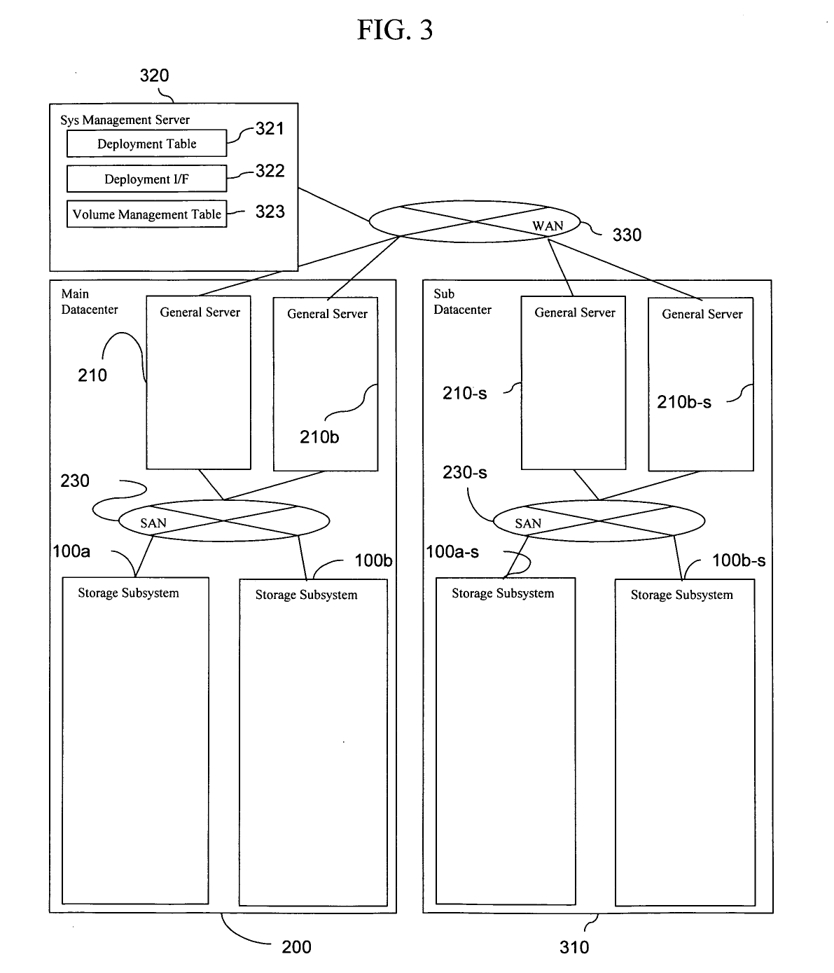

FIG. 3 illustrates an exemplary physical and logical system configuration involving two datacenters according to one aspect of the invention. The system has a main datacenter 200, a sub datacenter 310, and a system management server 320. These are connected via a wide area network (WAN) 330. This configuration is one example of the disaster recovery system. The data of the main datacenter 200 is mirrored to the sub datacenter 310. The user administrator controls volumes with the system management server 320. In FIG. 3, the system management server 320 is located outside the datacenter. In other embodiments, the system management server 320 can be located in the main datacenter 200 or in the sub datacenter 310. In addition, the system management server 320 can be located both in the main datacenter 200 and in the sub datacenter 320, providing redundancy architecture.

The main datacenter 200 has one or more general servers 210, 210b and one or more storage subsystems 100a, 100b. This datacenter architecture is shown in FIG. 2. Similarly, the sub datacenter 310 has one or more general servers 210-s, 210b-s and one or more storage subsystems 100a-s, 100b-s. This datacenter architecture is also shown in FIG. 2. The sub datacenter 310 is a backup of the main datacenter 200.

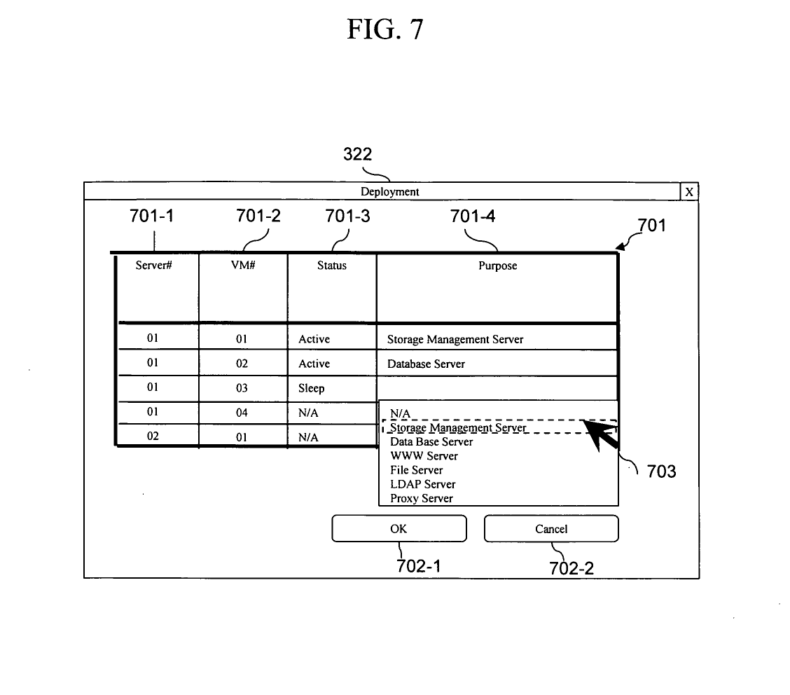

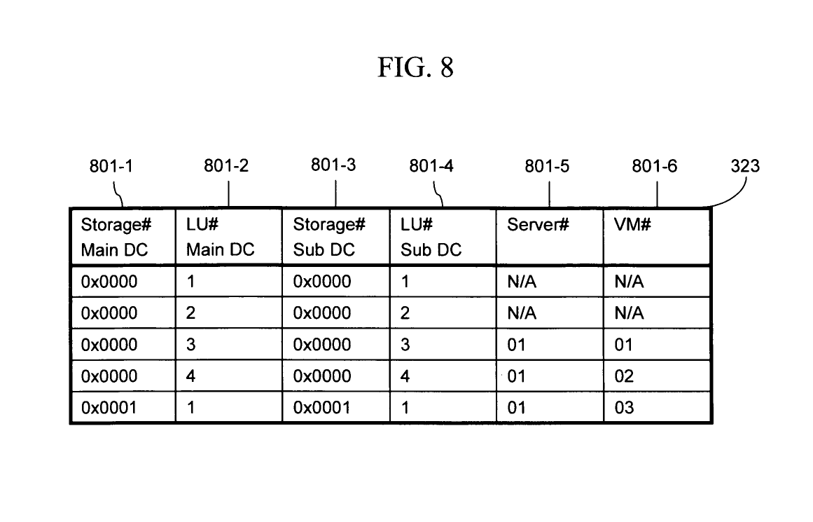

The user administrator controls volumes using the system management server 320. The system management server 320 has a deployment table 321, a deployment interface 322, and a volume management table 323. According to one example of the operation, the user administrator installs virtualized packages to the volumes, upgrades the virtualized packages, and relates several volumes with remote copy. The deployment interface 322 is shown in detail in FIG. 7. With this interface, the administrator installs virtualized packages to the storage volumes, and the administrator can do other operations described above. The deployment table 321 is a table that stores deployment result. The volume management table 323 is shown in detail in FIG. 8. The virtual server is specified with a server ID and a virtualized ID. This volume management table 323 stores the relationship between the server specification (server ID and virtualized ID) and the physical storage information (the main datacenter storage subsystem ID, LU, the sub datacenter storage subsystem ID, LU).

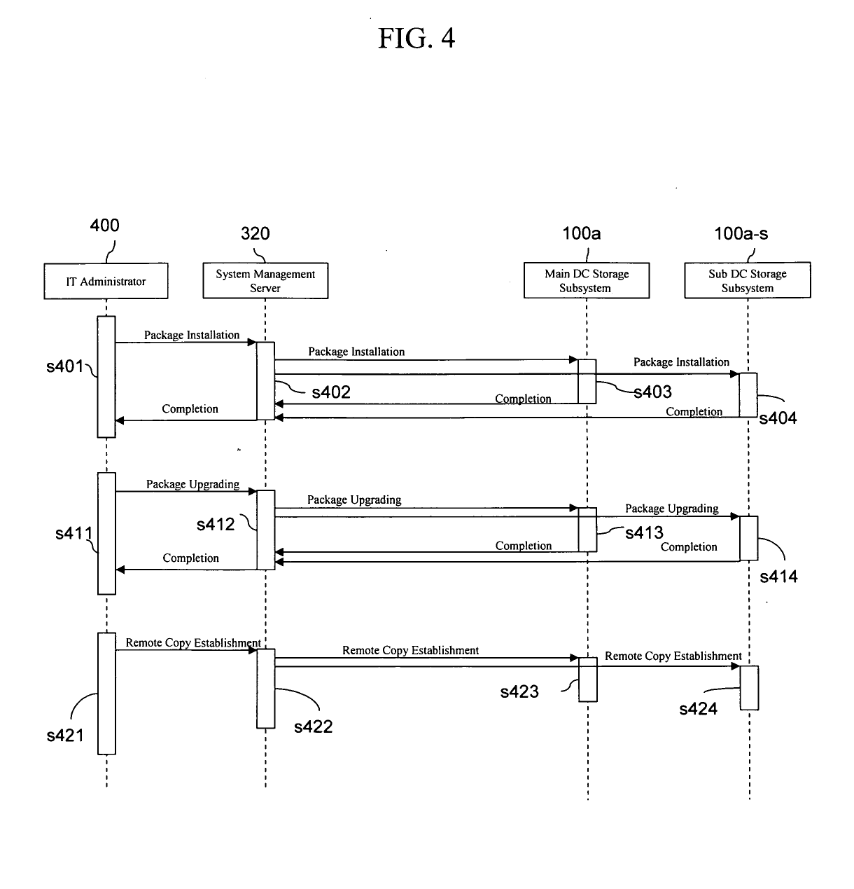

FIG. 4 illustrates the preparation and management of the virtualized objects according to a first embodiment of the invention. The IT administrator 400 executes steps to carry out this process via the system management server 320. The system management server 320 transfers orders or commands to the storage subsystem 100a of the main datacenter 200 and the storage subsystem 100a-s of the sub datacenter 310. The volume of the storage subsystem 100a of the main datacenter 200 is mirrored to the volume of the storage subsystem 100a-s of the sub datacenter 310. As a result of these steps, the virtualized object is stored in the storage subsystem 100a of the main datacenter 200 and the replicated object is stored in the storage subsystem 100a-s of the sub datacenter 310.

At status s401, the IT administrator 400 operates the system management server 320 to install one or more virtualized objects to the storage subsystems. The deployment I/F 322 is used. The administrator 400 selects the server ID, the virtualized machine ID and the virtualized object to install. At s402, the system management server 320 installs objects to the storage subsystems 100a, 100a-s. To find the storage subsystems 100a, 100a-s, the system management server 320 searches the volume management table 323. The system management server 320 converts the logical server information (the server ID and the virtualized machine ID) to the physical server information (the storage subsystem ID and the LDEV ID). After that, the system management server 320 sends orders to the storage subsystems 100a, 100a-s. At s403, the storage subsystem 100a of the main datacenter 200 receives the installation order and installs the objects. After installation, the storage subsystem 100a sends the completion message in reply to the system management server 320. At s404, the storage subsystem 100a-s of the sub datacenter 310 receives the installation order and installs the objects. After installation, the storage subsystem 100a-s sends the completion message in reply to the system management server 320. After the system management server 320 receives the completion messages from the storage subsystems 100a, 100a-s, the system management server 320 shows the completion message to the IT administrator 400.

The procedure from s411 to s414 shows how to upgrade virtualized objects. At status s411, the IT administrator 400 operates the system management server 320 to upgrade one or more virtualized objects in the storage subsystems. The deployment I/F 322 is used. The administrator 400 selects the server ID, the virtualized machine ID and the virtualized object to upgrade. At s412, the system management server 320 upgrades the objects in the storage subsystems 100a, 100a-s. To find the storage subsystem 100a, 100a-s, the system management server 320 searches the volume management table 323. The system management server 320 converts the logical server information (the server ID and the virtualized machine ID) to the physical server information (the storage subsystem ID and the LDEV ID). After that, the system management server 320 sends orders to the storage subsystems 100a, 100a-s. At s413, the storage subsystem 100a of the main datacenter 200 receives the upgrading order and upgrades the objects. After upgrading, the storage subsystem 100a sends the completion message in reply to the system management server 320. At s414, the storage subsystem 100a-s of the sub datacenter 310 receives the upgrading order and upgrades the objects. After upgrading, the storage subsystem 100a-s sends the completion message in reply to the system management server 320. After the system management server 320 receives the completion messages from the storage subsystems 100a, 100a-s, the system management server 320 shows the completion message to the IT administrator 400.

The procedure from s421 to s424 shows how to relate two volumes using remote copy. At status s421, the IT administrator 400 operates the system management server 320 to establish remote copy between two volumes in two datacenters. The IT administrator 400 may not need to issue this order; instead, the system management server 320 can automatically establish remote copy after receiving the completion messages (at s402 and s412). At s422, the system management server 320 sends remote copy establishment messages to the storage subsystems 100a, 100a-s. At s423, the storage subsystem 100a of the main datacenter 200 changes the status, and the status is stored in the remote copy management table 222. At s424, the storage subsystem 100a-s of the sub datacenter 310 changes the status, and the status is stored in the remote copy management table as well. In an alternative embodiment, this remote copy establishment message is only sent to the storage subsystem 100a of the main datacenter 200.

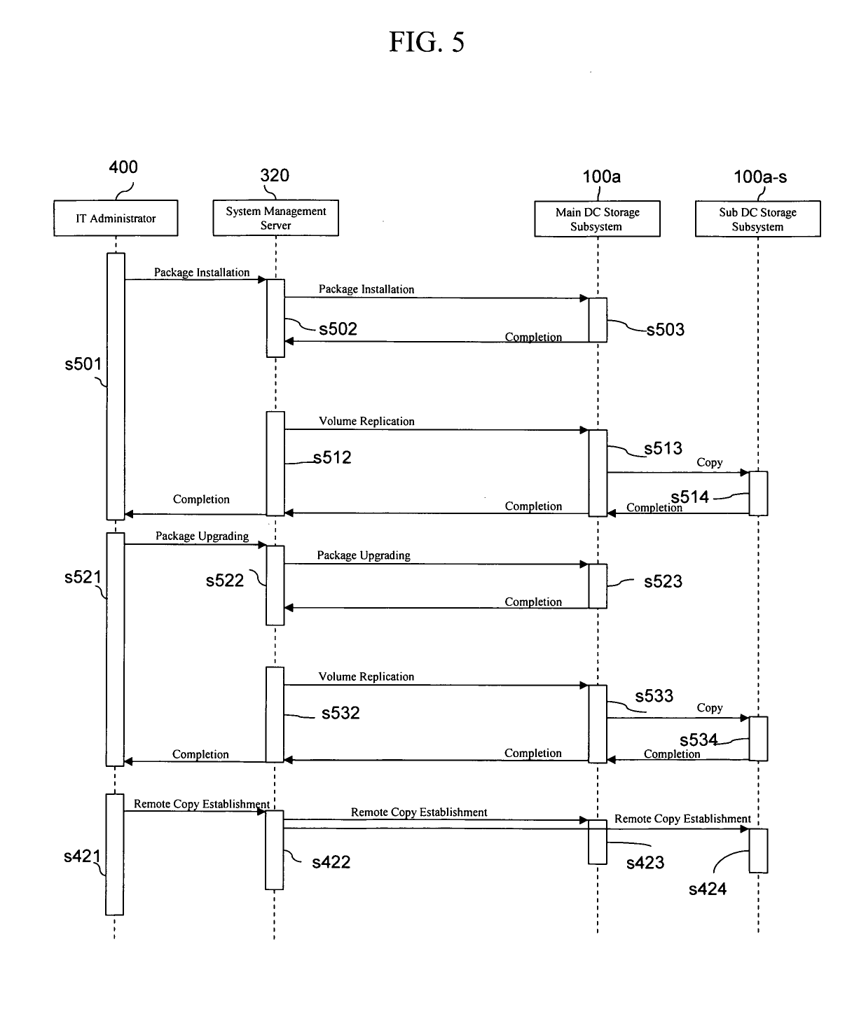

FIG. 5 illustrates the preparation and management of the virtualized objects according to a second embodiment of the invention. In FIG. 4 of the first embodiment, the same virtualized object is installed simultaneously to the storage subsystem 100a volume of the main datacenter 200 and the storage subsystem 100a-s of the sub datacenter 310. If the IT administrator 400 has the virtualized object in advance, or the virtualized object is stored somewhere, the process in the FIG. 4 is workable. In the second embodiment shown in FIG. 5, the virtualized object is not installed simultaneously, but it is first installed to the storage subsystem 100a of the main datacenter 200, and replicated to the storage subsystem 100a-s of the sub datacenter 310. The replication can be executed with remote copy.

At status s501, the IT administrator 400 operates the system management server 320 to install one or more virtualized objects to the storage subsystems. The deployment I/F 322 is used. The administrator 400 selects the server ID, the virtualized machine ID and the virtualized object to install. At s502, the system management server 320 installs objects to the storage subsystem 100a of the main datacenter 200. To find the storage subsystem 100a, the system management server 320 searches the volume management table 323. The system management server 320 converts the logical server information (the server ID and the virtualized machine ID) to the physical server information (the storage subsystem ID and the LDEV ID). After that, the system management server 320 sends an order to the storage subsystem 100a. At s503, the storage subsystem 100a receives the installation order and installs the objects. After installation the storage subsystem 100a sends the completion message in reply to the system management server 320.

At status s512, after the system management server 320 receives the completion messages from the storage subsystem 100a of the main datacenter 200, the system management server 320 sends an order to replicate the volume of the storage subsystem 100a of the main datacenter 200 to the storage subsystem 100a-s of the sub datacenter 310. The physical information of the storage subsystems 100a, 100a-s is searched in the volume management table 323. At s513, the storage subsystem 100a of the main datacenter 200 receives the order to replicate the data. The storage subsystem 100a changes its status in the remote copy management table 222, and begins remote copy. The remote copy status is COPY (especially INITIAL COPY).

At s514, the storage subsystem 100a-s of the sub datacenter 310 receives the volume data of the storage subsystem 100a of the main datacenter 200. After the COPY status finishes, the storage subsystem 100a-s of the sub datacenter 310 sends the completion message to the storage subsystem 100a of the main datacenter 200. The storage subsystem 100a receives the completion message, and changes the remote copy status to SPLIT. The storage subsystem 100a sends a completion message to the system management server 320, and the storage management server 320 shows the message to the IT Administrator 400.

The procedure from s521 to s534 shows how to upgrade virtualized objects. At status s521, the IT administrator 400 operates the system management server 320 to upgrade one or more virtualized objects to the storage subsystems. The deployment I/F 322 is used. The administrator 400 selects the server ID, the virtualized machine ID and the virtualized object to upgrade. At s522, the system management server 320 upgrades objects to the storage subsystems (100a) of the main datacenter 200. To find the storage subsystem 100a, the system management server searches the volume management table 323. The system management server 320 converts the logical server information (the server ID and the virtualized machine ID) to the physical server information (the storage subsystem ID and the LDEV ID). After that, the system management server 320 sends an order to the storage subsystem 100a. At s523, the storage subsystem 100a receives the upgrading order and upgrades the objects. After upgrading, the storage subsystem 100a sends the completion message in reply to the system management server 320.

At s532, after the system management server 320 receives the completion messages from the storage subsystem 100a of the main datacenter 200, the system management server 320 orders to replicate the volume of the storage subsystem 100a of the main datacenter 200 to the storage subsystem 100a-s of the sub datacenter 310. The physical information of the storage subsystems 100a, 100a-s is searched in the volume management table 323. At s533, the storage subsystem 100a of the main datacenter 200 receives the order to replicate the data. The storage subsystem 100a changes its status in the remote copy management table 222, and begins remote copy. The remote copy status is COPY. At s534, the storage subsystem 100a-s of the sub datacenter 310 receives the volume data of the storage subsystem 100a. After the COPY status finishes, the storage subsystem 100a-s of the sub datacenter 310 sends the completion message to the storage subsystem 100a of the main datacenter 200. The storage subsystem 100a receives the completion message, and changes the remote copy status to SPLIT. The storage subsystem 100a of the main datacenter 200 sends the completion message to the system management server 320, and the storage management server 320 shows the message to the IT Administrator 400.

The procedure from s421 to s424 shows how to relate two volumes with remote copy. This process is described above in connection with FIG. 4.

Referring to FIGS. 4 and 5, there are several combinations to prepare the same virtualized object in the storage subsystems 100a, 100a-s. For example, the virtualized object is installed using the procedure from s401 to s404. After that, those objects are related with remote copy using the procedure from s421 to s424. The remote copy status is SPLIT. When the IT administrator 400 upgrades, the IT administrator 400 changes the remote copy status to COPY (PAIR), boots the general server of the main datacenter 200 with the virtualized object, and upgrades. This change data is transferred to the volume of the storage subsystem 100a-s in the sub datacenter 310 with remote copy. After all the change data is transferred, the storage subsystem 100a sends the completion message to the system management server 320, and changes the remote status to SPLIT.

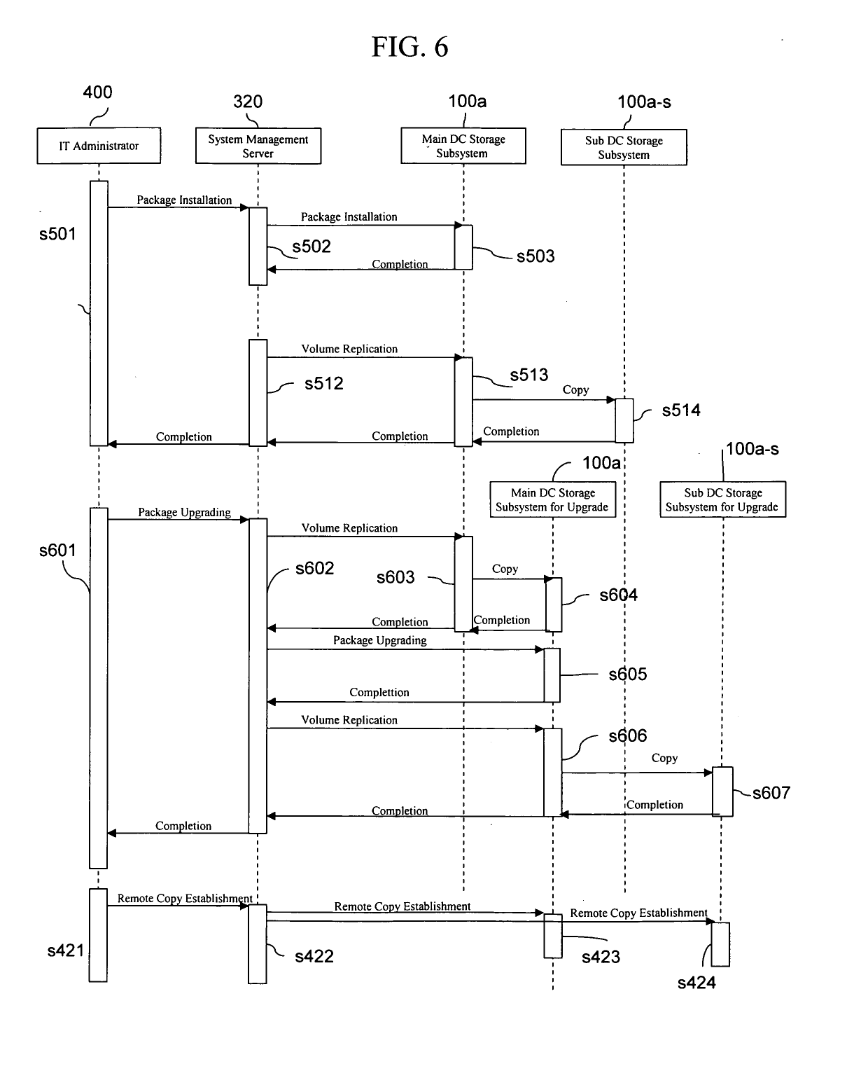

FIG. 6 illustrates the preparation and management of the virtualized objects according to a third embodiment of the invention. In FIGS. 4 and 5 of the previous embodiments, when the IT administrator 400 upgrades the virtualized object, the system management server 320 orders to overwrite the stored data. In FIG. 6, when the IT administrator 400 upgrades the virtualized object, the system management server 320 orders to make another volume (not overwrite). This is effective when the IT administrator 400 may need to use the virtualized object of the old version after the upgrading. Additionally the operation is not limited only to upgrading. The operation can be used for parameter modification or the assortment modification of the libraries. In those cases, there is a need for the IT administrator 400 to use the former virtualized object.

The procedure from s501 to s514 shows how to prepare the same virtualized objects in the storage subsystems 100a and 100a-s. This process is described above in connection with FIG. 5.

At status s601, the IT administrator 400 operates to upgrade the virtualized object. The IT administrator 400 operates the system management server 320 to upgrade one or more virtualized object to the storage subsystem. The deployment I/F 322 is used. The administrator 400 selects the server ID, the virtualized machine ID and the virtualized object to upgrade. At s602, the system management server 320 selects the storage subsystem that has the source virtualized object. The system management server 320 sends the replication message to the source storage subsystem. At s603, the source storage subsystem receives the replication order and begins to copy to the other volume. In FIG. 6, the source virtualized object is replicated within the same storage subsystem. In an alternate embodiment, the source virtualized object can be replicated by copying it to the volume of a different storage subsystem. At s604, the virtualized object is stored in the other volume, and the completion message is sent to the system management server 320.

After the system management server 320 receives the completion message, the system management server 320 begins to upgrade. This involves the procedure from s605 to s607, which is the same as the procedure from s523 to s534 described above in connection with FIG. 5. The procedure from s421 to s424 shows how to relate two volumes with remote copy. This procedure is described above in connection with FIG. 4.

FIG. 7 illustrates an example of the deployment interface 322. The IT administrator 400 operates the system management server 320 and deploys the virtualized objects to the storage subsystem with this interface. The deployment interface 322 employs a table 701 that includes the identification of the object (server ID 701-1, VM ID 701-2), the status 701-3, and the purpose of the object 701-4. With the server ID 701-1 and VM ID 701-2, the volume of the storage subsystem can be defined unique. This identification is related to the physical information of the storage subsystem in the volume management table 323. The IT administrator 400 can change this identification. The VM status 701-3 shows the virtual machine status. If the status is Active, the virtual machine has already been booted. The purpose 701-4 shows the purpose of the virtual machine. This alternative can be edited by the administrator. The location information of the object is stored somewhere in the system management server 320. The deployment interface 322 includes a button OK 701-1 to execute and a button Cancel 701-2 to cancel. Reference numeral 703 shows alternative entries in column 701-4 listing the purpose of the object.

FIG. 8 illustrates an example of the volume management table 323 for the two datacenter model of FIG. 3. The system management server 320 converts the logical identifications of the object to the physical information of the storage subsystem with this table 323. The IT administrator selects the logical identifications of the object with the deployment interface 322. For example, “The server ID is 01, and the virtual machine ID is 02.” The system management server 320 finds the physical address related to the object information. In this case, “The storage subsystem ID in the main datacenter is 0x0000 and the logical unit ID is #4. The storage subsystem ID in the sub datacenter is 0x0000 and the logical unit ID is #4.” This table includes the server ID 801-5 and the virtual machine ID 801-6. These parameters are shown in the deployment interface 322. For the storage subsystem ID in the main datacenter 200 (column 801-1), the logical unit ID in the main datacenter 200 in column 801-2 is the physical identification of the volume. For the storage subsystem ID in the sub datacenter 310 (column 801-3), the logical unit ID in the sub datacenter in column 801-4 is the physical identification of the volume. It is noted that the physical identification can be some other parameters that can identify the volume uniquely.

FIG. 9 illustrates an example of the remote copy management table 222. The storage subsystem has the remote copy management table 222 to manage remote copy. In this table the source volume is related with the target volume. To identify the source volume, logical device information such as LDEV# is stored in column 901-1. In the storage subsystem the volume is identified uniquely. The logical unit ID is stored in column 901-2. This parameter is not always required. Column 901-3 stores the information of the paired storage subsystem ID. The paired volume is identified uniquely with this storage subsystem ID in column 901-3 and the logical unit ID in column 901-4. Alternatively, the logical unit ID in column 901-4 can be substituted by the logical device ID. Column 901-5 shows the pair status of the remote copy. The status of “COPY,” “PAIR,” or “SPLIT” is stored in this column. When the storage subsystem 100a receives the write system call, the storage subsystem 100a searches in this remote copy management table 222. If the volume is registered as a source volume of the remote copy, the storage subsystem 100a transfers the write information to the target system volume.

FIG. 10 illustrates an example of the local copy management table 223. The storage subsystem has the local copy management table 223 to manage local copy. In this table the source volume is related with the target volume. To identify the source volume, logical device information is stored in column 1001-1. In the storage subsystem the volume is identified uniquely. Column 1001-2 stores the information of the paired storage subsystem ID. The paired volume is identified uniquely with the logical device ID in 1001-2. Column 1001-3 shows the pair status of the local copy. The volume is replicated in accordance with this table.

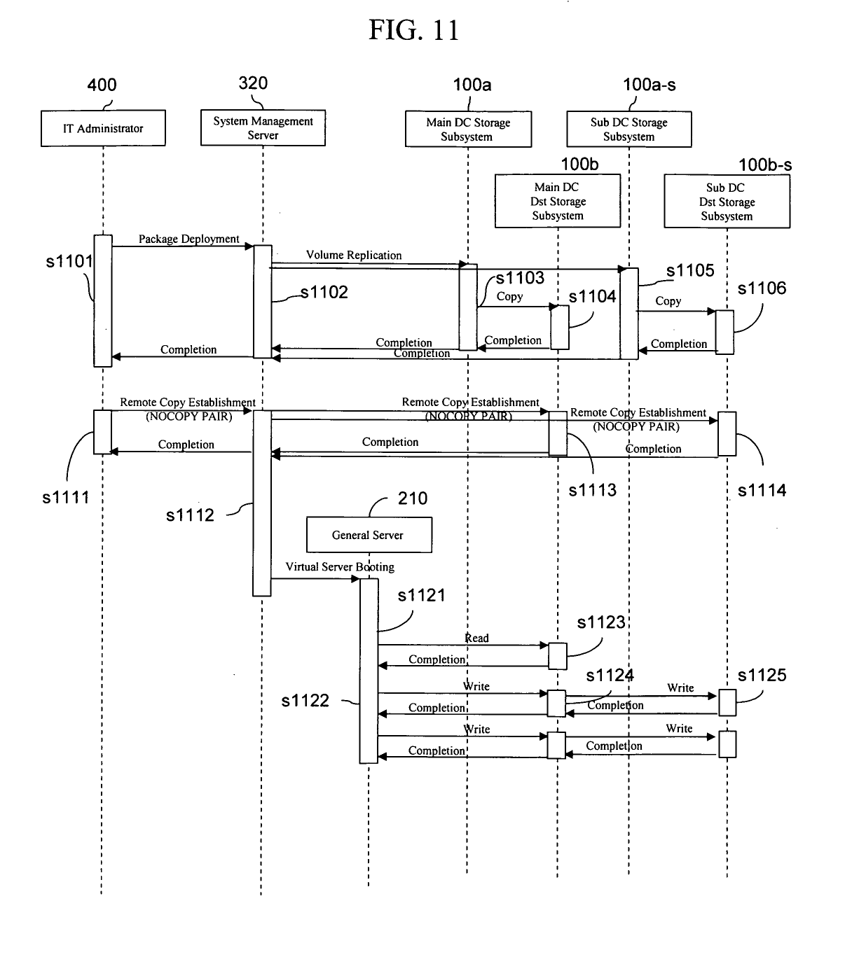

FIG. 11 illustrates an example of the usage of the virtualized object by the general server. After the virtualized object is prepared in the main datacenter 200 and the sub datacenter 310, the IT administrator 400 follows the procedures shown FIG. 11 to deploy the virtualized object.

The procedure from s1101 to s1106 shows how to deploy the prepared virtualized object. At status s1101, the IT administrator 400 orders to deploy the virtualized object with the system management server 320. The IT administrator 400 uses the deployment interface 322, and selects the server and the purpose. At s1102, the system management server 320 searches the volume in which the virtualized object is stored. The system management server 320 uses the volume management table 323 for the search. Additionally, the system management server 320 searches the physical information of the target volume. At s1103, the storage subsystem 100a of the main datacenter 200 receives the message to replicate the virtualized object to the target volume. This target volume can be in the same storage subsystem. In FIG. 11, the target volume is in the different storage subsystem 100b of the main datacenter 200. At s1104 the virtualized object is replicated in the storage subsystem 100b, and after that the storage subsystem 100b sends the completion message to the source storage subsystem 100a. The source storage subsystem 100a then sends the completion message to the system management server 320. The statuses s1105 and s1106 for the storage subsystems 100a-s and 100b-s in the sub datacenter 310 are similar to the statuses s1103 and s1104 for the storage subsystems 100a and 100b in the main datacenter 200. After the system management server 320 receives the completion message from both source storage subsystems in the two datacenters, the system management server 320 shows the completion message to the IT administrator 400.

The procedure from s1102 to s1113 to s1114 shows how to relate the deployed volumes with remote copy. The replicated objects (one in the main datacenter 200; the other in the sub datacenter 310) are stored in the storage, and the volume image is the same. To make judgments that the volumes are the same, the system management server 320 can compare the volumes. For example, the system management server 320 can calculate the hash value of each volume and compare them.

As seen in FIG. 11, the IT administrator 400 makes judgments to establish remote copy (PAIR with NOCOPY) at s1101. FIG. 11 shows a process that does not require the IT administrator 400 to initiate the remote copy procedure separately after completion of the package deployment. The system management server 320 does it automatically. At s1102, the system management server 320 searches the physical information of the replicated volumes, and sends the message to them. The order is to establish remote copy and set the status as PAIR with NOCOPY. In an alternative embodiment, the IT administrator operates the system management server 320 to establish remote copy, and set the status as PAIR with NOCOPY.

At s1113, the storage subsystem 100b in the main datacenter 200 receives the message, and changes the remote copy status. The information is stored in the remote copy management table 222. The physical information of the storage subsystem 100b-s in the sub datacenter 310 is stored in this table, and the storage subsystem 100b in the main datacenter 200 changes the status as COPY(S). After that, the completion message is sent to the system management server 320. At s1114, the storage subsystem 100b-s in the sub datacenter 310 receives the message that the volume in the storage subsystem 100b-s is related with the volume in the storage subsystem 100b in the main datacenter 200. This status s1114 can be omitted. After the system management server 320 receives the completion message from the storage subsystem 100b, the system management server 320 orders the general server 210 to boot the virtual server.

At s1121, the general server 210 boots the virtual server. The object of the virtual server is stored in the storage subsystem 100b of the main datacenter 200. The general server 210 sends Read/Write information to the storage subsystem 110b. If the information is to read the volume, the storage subsystem 100b sends the contents in reply. If the information is to write the volume, the storage subsystem 100b replies and transfers the write information to the remote copy target volume. FIG. 11 shows a procedure from s1121 to s1123 when the information is to read the volume data, and a procedure from s1121 to s1124 and s1125 when the information is to write the volume data. If the remote copy is synchronous, the write information to the storage subsystem 100b in the main datacenter 200 is immediately transferred to the storage subsystem 100b-s in the sub datacenter 310. The synchronous remote copy is shown in FIG. 11. If the remote copy is asynchronous, the write information is stored, and a lot of accumulated write information is transferred at once. If the distance of the datacenters is long, the asynchronous remote copy may be preferable. If not, the synchronous remote copy system can be applied.

An important aspect of the invention is the procedure from s1101 to s1114. The IT administrator 400 manages the same virtualized objects (SOURCE) in the main datacenter 200 and in the sub datacenter 310 in advance. These SOURCE objects are ensured that they are the same. They are related with remote copy, and the status is SPLIT. The IT administrator 400 deploys virtualized object using the SOURCE. In the main datacenter 200, the IT administrator 400 copies the SOURCE in the main datacenter to the volumes in the main datacenter. The IT administrator 400 does the same in the sub datacenter 310. After that, the IT administrator 400 relates the replicated two volumes with remote copy. The replicated volumes are the same, so the status can be set as PAIR with NOCOPY. If the IT administrator uses the traditional remote copy, it is required to replicate all the source volume data to the target volume. It is necessary for the volume data of the main datacenter to be transferred to the sub datacenter. This requires a large bandwidth between the main datacenter 200 and the sub datacenter 310 to achieve the PAIR status. If the datacenters are large in scale, this impact is significant. The initial copyless remote copy of the present invention avoids this problem.

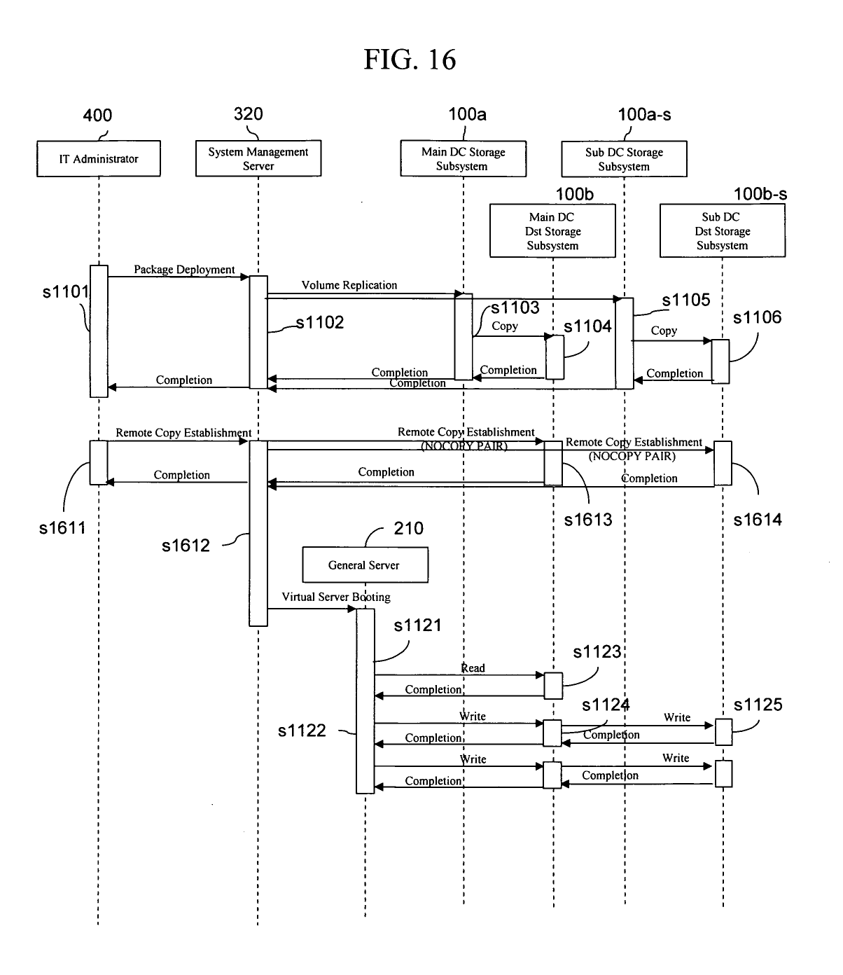

FIG. 16 illustrates another example of the usage of the virtualized object by the general server. FIG. 16 is similar to the FIG. 11; the difference is the procedure from s1102 to s1613 and s1614. According to the procedure in FIG. 11, the IT administrator 400 makes judgments to establish remote copy (PAIR with NOCOPY) at s1101. In FIG. 16, the IT administrator does not make judgments as to whether to use the NOCOPY option. Instead, the system management server 320 makes judgments at s1102. The procedure from s1102 to s1613 to s1614 is used to establish remote copy with two volumes. At s1102, the system management server 320 makes judgments to establish remote copy (PAIR with NOCOPY). The system management server 320 sends a message to establish remote copy, and sets the status as PAIR with NOCOPY. The system management server 320 manages the SOURCE volume with remote copy (SPLIT), to ensure that the volumes prepared in the procedure from s1101 to s1106 are the same. The system management server 320 can make judgments by comparing the hash values of the volumes. The statuses s1613 and s1614 in FIG. 16 are the same as the statuses s1113 and s1114 in FIG. 11.

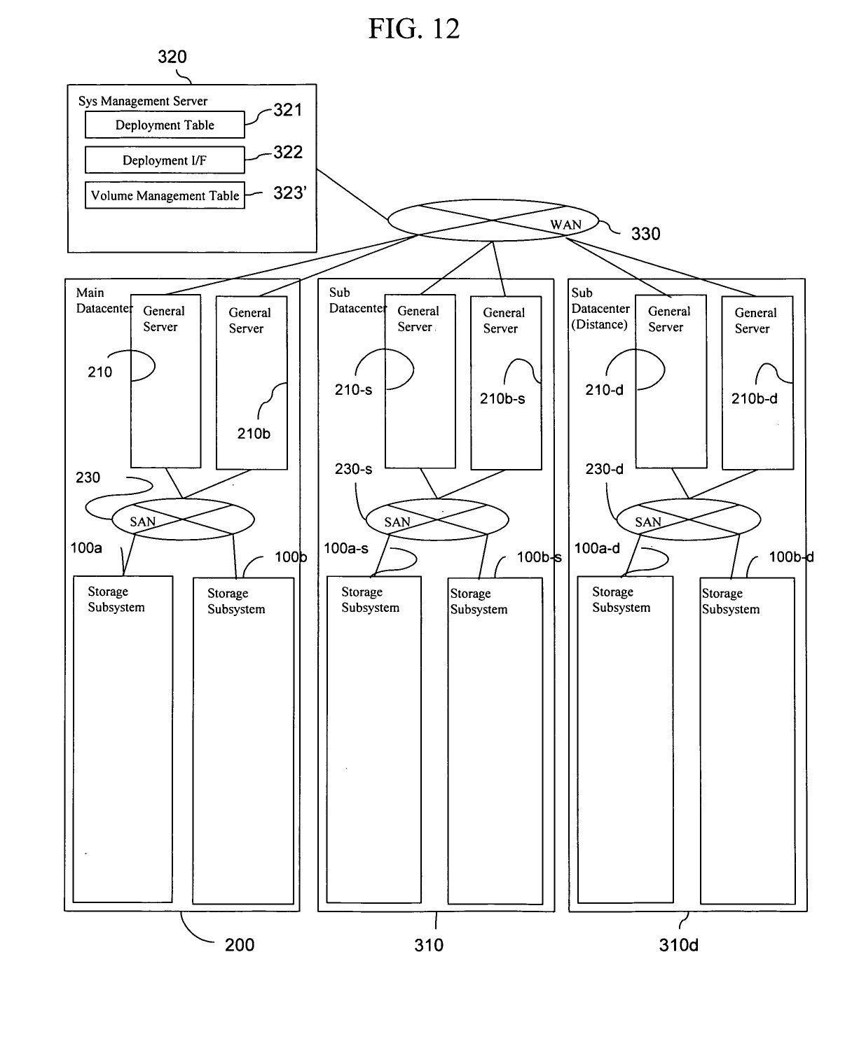

FIG. 12 illustrates an exemplary physical and logical system configuration involving three datacenters according to another aspect of the invention. The system has a main datacenter 200, two sub datacenters 310, 310d, and a system management server 320. They are connected via a network 330 which is a WAN in the embodiment shown. This structure is one example of the disaster recovery system. The data of the main datacenter 200 is mirrored to the sub datacenters 310, 310d. The first sub datacenter 310 is comparatively near the main datacenter 200, and the second sub datacenter 310d is comparatively far from the main datacenter 200. In this case, the user administrator 400 also controls the volumes with the system management server 320.

The main datacenter 200 has one or more general servers 210, 210b and one or more storage subsystems 100a, 100b. The datacenter architecture is shown in FIG. 2. Similarly, the first sub datacenter 310 has one or more general servers 210-s, 210b-s and one or more storage subsystems 100a-s, 100b-s. The datacenter architecture is shown in FIG. 2. The first sub datacenter 310 is a backup of the main datacenter 200. The second sub datacenter 310d has one or more general servers 210-d, 210b-d and one or more storage subsystems 100a-d, 100b-d. The datacenter architecture is shown in FIG. 2. The second sub datacenter 310d is another backup of the main datacenter 200.

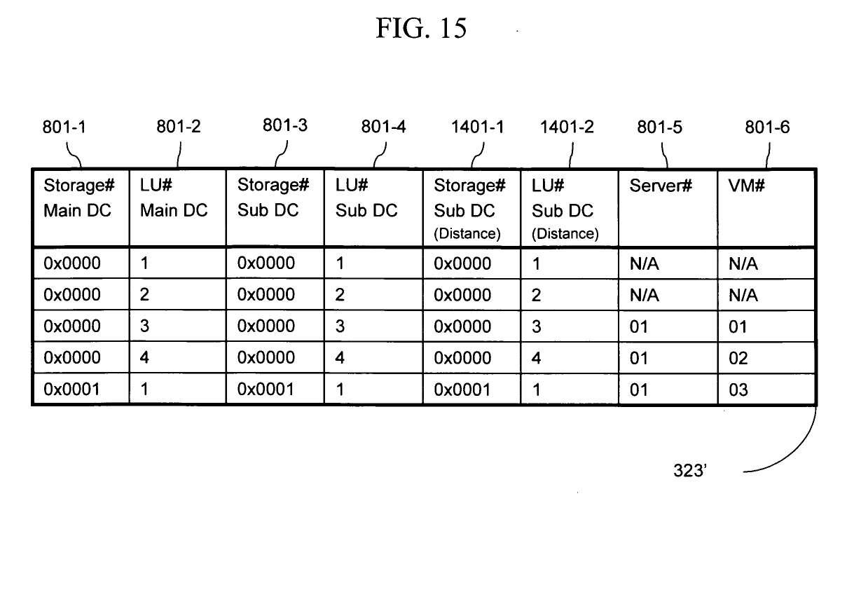

The user administrator 400 controls volumes using the system management server 320. The system management server 320 has a deployment table 321, a deployment interface 322, and a volume management table 323′. According to one example of the operation, the user administrator installs virtualized packages to the volumes, upgrades the virtualized packages, and relates several volumes with remote copy. The deployment interface 322 is shown in detail in FIG. 7. With this interface, the administrator installs virtualized packages to the storage volumes, and the administrator can do other operations described above. The deployment table 321 is a table that stores deployment result. The volume management table 323′ is shown in detail in FIG. 15. The virtual server is specified with a server ID and a virtualized ID. This volume management table 323′ stores the relationship between the server specification (server ID and virtualized ID) and the physical storage information (the main datacenter storage subsystem ID, LU, the sub datacenter storage subsystem ID, LU).

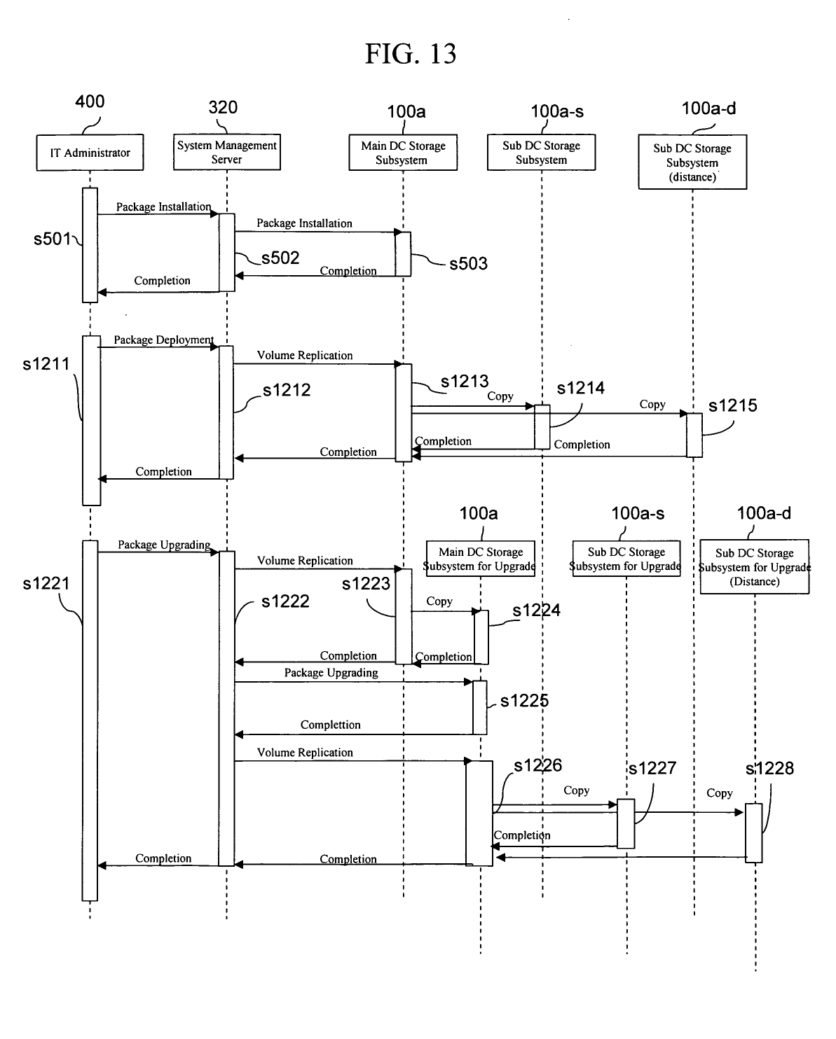

FIG. 13 illustrates the preparation and management of the virtualized objects for the three datacenter model of FIG. 12 according to one embodiment of the invention. FIG. 13 is similar to FIG. 6; the difference is the number of the sub datacenters. In FIG. 13, when the IT administrator 400 upgrades the virtualized object, the system management server 320 orders to make another volume (not overwrite). This is effective when the IT administrator 400 may need to use the virtualized object of the old version after the upgrading. Additionally the operation is not limited only to upgrading. The operation can be used for parameter modification or the assortment modification of the libraries. In those cases, there is a need for the IT administrator 400 to use the former virtualized object.

The procedure from s501 to s503 shows how to prepare the same virtualized objects in the storage subsystem 100a in the main datacenter 200. This process is described above in connection with FIG. 5.

The procedure from s1211 to s1214 shows how to prepare the same virtualized objects in the storage subsystem 100a-s in the first sub datacenter 310. This process is similar to the process from s501 to s512-s514, which described above in connection with FIG. 5. The status s1215 is added to show how to prepare the same virtualized objects in the storage subsystem 100a-d of the second sub datacenter 310d, and it is similar to the status 1214 but applied to the storage subsystem 100a-d of the second sub datacenter 310d.

The procedure from s1221 to s1227 shows how to upgrade the virtualized object in the storage subsystem 100a of the main datacenter 200 and in the storage subsystem 100a-s of the first sub datacenter 310. The procedure from s1221 to s1227 is similar to the procedure from s601 to s607 in FIG. 6. The status s1228 is added in FIG. 13 to show how to upgrade the virtualized object in the storage subsystem 100a-d of the second sub datacenter 310d, and it is similar to the status s1227 but applied to the storage subsystem 100a-d of the second sub datacenter 310d. Finally, the remote copy is established between the virtualized objects either after s1211-s1215 or after s1221-s1228.

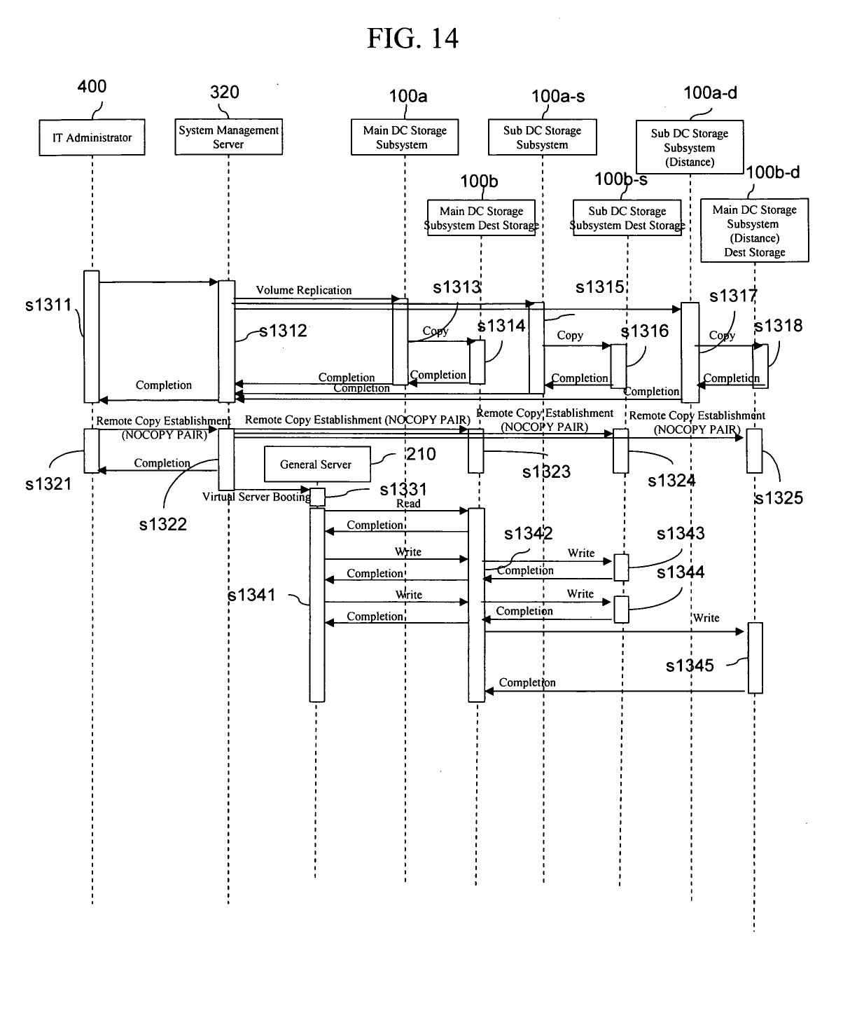

FIG. 14 illustrates an example of the usage of the virtualized object by the general server for the three datacenter model of FIG. 12. FIG. 14 is similar to the FIG. 11; the difference is the number of the datacenters. The package deployment procedure for the virtualized object from s1311 to s1316 in FIG. 14 is the same as the procedure from s1101 to s1106 in FIG. 6 and in FIG. 11. The procedure from s1317 to s1318 is added in FIG. 14 to show how to deploy the prepared virtualized object in the storage subsystems 100a-d and 100b-d of the second sub datacenter 310d. The procedure from s1312 to s1323 and s1324 in FIG. 14 is the same as the procedure from s1102 to s1113 and s1114 in FIG. 11 to relate the deployed volumes with remote copy. The status s1325 is added in FIG. 14 to show how to relate the deployed volumes with remote copy for the storage subsystem 100b-d of the second sub datacenter 310d, and is similar to s1324 but applied to the storage subsystem 100b-d of the second sub datacenter 310d. The procedure from s1331 to s1344 in FIG. 14 is the same as the procedure from s1121 to s1125 in FIG. 11. The status s1345 is added to show how to write the volume data in the storage subsystem 100b-d of the second sub datacenter 310d. The status s1345 shows that the volume in the storage subsystem 100b of the main datacenter 200 and the volume in the storage subsystem 100b-d of the second sub datacenter 310d are related with asynchronous remote copy.

FIG. 15 illustrates an example of the volume management table 323′ for the three datacenter model of FIG. 12. The system management server 320 converts the logical identifications of the object to the physical information of the storage subsystem with this table 323′. The IT administrator selects the logical identifications of the object with the deployment interface 322. For example, “The server ID is 01, and the virtual machine ID is 02.” The system management server 320 finds the physical address related to the object information. In this case, “The storage subsystem ID in the main datacenter is 0x0000 and the logical unit ID is #4. The storage subsystem ID in the sub datacenter is 0x0000 and the logical unit ID is #4.” This table includes the server ID 801-5 and the virtual machine ID 801-6. These parameters are shown in the deployment interface 322. For the storage subsystem ID in the main datacenter 200 (column 801-1), the logical unit ID in the main datacenter 200 in column 801-2 is the physical identification of the volume. For the storage subsystem ID in the first sub datacenter 310 (column 801-3), the logical unit ID in the sub datacenter in column 801-4 is the physical identification of the volume. In this table 323′, the physical information of the volume in the second sub datacenter 310d is added (1401-1, 1401-2). For additional datacenters in the system, additional columns are provided to show the physical information of the volume in the storage subsystems of the additional datacenters.

From the foregoing, it will be apparent that the invention provides methods, apparatuses and programs stored on computer readable media for initial copyless remote copy to reduce data traffic. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. A computer system comprising:
a first datacenter having at least one computer device connected to at least one storage device via a first datacenter network, the at least one storage device including a first source volume; and
a second datacenter having at least one computer device connected to at least one storage device via a second datacenter network, the at least one storage device including a second source volume;
wherein the first datacenter and the second datacenter are connected via a network;
wherein, prior to establishment of remote copy of deployed volumes between the first datacenter and the second datacenter, the first source volume of the first datacenter and the second source volume of the second datacenter have identical source objects;
wherein, during establishment of remote copy of deployed volumes between the first datacenter and the second datacenter, the first datacenter replicates the source object in the first source volume to a first target volume, the second datacenter replicates the source object in the second source volume to a second target volume, and a first replicated object in the first target volume of the first datacenter and a second replicated object in the second target volume of the second datacenter are related to each other by remote copy with no copying therebetween.

2. A computer system according to claim 1, wherein the source object in the first source volume of the first datacenter and the source object in the second source volume of the second datacenter are related by remote copy at SPLIT status.

3. A computer system according to claim 1, wherein the first replicated object in the first target volume of the first datacenter and the second replicated object in the second target volume of the second datacenter are related by remote copy at PAIR with NOCOPY status.

4. A computer system according to claim 1, wherein, prior to establishment of remote copy of deployed volumes between the first datacenter and the second datacenter, the identical source objects are virtualized source objects that are installed and upgraded simultaneously in the first source volume of the first datacenter and the second source volume of the second datacenter.

5. A computer system according to claim 1, wherein, prior to establishment of remote copy of deployed volumes between the first datacenter and the second datacenter, the source object is a virtualized source object that is installed in the first source volume of the first datacenter and is then replicated from the first source volume of the first datacenter to the second source volume of the second datacenter, and the source object is upgraded in the first source volume of the first datacenter and is then replicated from the first source volume of the first datacenter to the second source volume of the second datacenter.

6. A computer system according to claim 1, wherein, prior to establishment of remote copy of deployed volumes between the first datacenter and the second datacenter, the source objects are virtualized source objects that are installed and upgraded in the first source volume of the first datacenter and the second source volume of the second datacenter, and the upgraded objects do not overwrite the installed objects.

7. A computer system according to claim 1, further comprising:
a third datacenter having at least one computer device connected to at least one storage device via a third datacenter network, the at least one storage device including a third source volume;
wherein the first datacenter, the second datacenter, and the third datacenter are connected via the network;
wherein, prior to establishment of remote copy of deployed volumes between the first datacenter and the third datacenter, the first source volume of the first datacenter and the third source volume of the third datacenter have identical source objects;
wherein, during establishment of remote copy of deployed volumes between the first datacenter and the third datacenter, the first datacenter replicates the source object in the first source volume to the first target volume, the third datacenter replicates the source object in the third volume to a third target volume, and the first replicated object in the first target volume of the first datacenter and a third replicated object in the third target volume of the third datacenter are related to each other by remote copy with no copying therebetween.

8. A computer system comprising:
a first datacenter having at least one computer device connected to at least one storage device via a first datacenter network, the at least one storage device including a first source volume;
a second datacenter having at least one computer device connected to at least one storage device via a second datacenter network, the at least one storage device including a second source volume; and
a management computer connected to the first datacenter and the second datacenter via a network;
wherein, prior to establishment of remote copy of deployed volumes between the first datacenter and the second datacenter, the first source volume of the first datacenter and the second source volume of the second datacenter have identical source objects;
wherein, during establishment of remote copy of deployed volumes between the first datacenter and the second datacenter, the management computer is configured to order the first datacenter to replicate the source object in the first source volume to a first target volume and to order the second datacenter to replicate the source object in the second source volume to a second target volume, and to establish remote copy with no copying between a first replicated object in the first target volume of the first datacenter and a second replicated object in the second target volume of the second datacenter.

9. A computer system according to claim 8, wherein after the first datacenter replicates the source object in the first source volume to the first target volume and the second datacenter replicates the source object in the second source volume to the second target volume, the management computer automatically relates the first replicated object in the first target volume of the first datacenter and the second replicated object in the second target volume of the second datacenter by remote copy and sets the remote copy at PAIR with NOCOPY status.

10. A computer system according to claim 8, wherein, prior to establishment of remote copy of deployed volumes between the first datacenter and the second datacenter, the management computer is configured to instruct the first datacenter and the second datacenter to install and upgrade the identical source objects, which are virtualized source objects, in the first source volume of the first datacenter and the second source volume of the second datacenter.

11. A computer system according to claim 8, wherein the management computer is configured to calculate hash values of the first target volume of the first datacenter and the second target volume of the second datacenter, and to compare the hash values to ascertain that the first target volume and the second target volume have the same objects.

12. A computer system according to claim 8, further comprising:
at least one additional datacenter each having at least one computer device connected to at least one storage device via an additional datacenter network, the at least one storage device including an additional source volume;
wherein the first datacenter, the second datacenter, and the at least one additional datacenter are connected via the network;
wherein, prior to establishment of remote copy of deployed volumes between the first datacenter and the at least one additional datacenter, the first source volume of the first datacenter and the additional source volume of each of the at least one additional datacenter have identical source objects;
wherein, during establishment of remote copy of deployed volumes between the first datacenter and the at least one additional datacenter, the first datacenter replicates the source object in the first source volume to the first target volume, each of the at least one additional datacenter replicates the source object in the additional volume to an additional target volume, and the first replicated object in the first target volume of the first datacenter and an additional replicated object in the additional target volume of each of the at least one additional datacenter are related to each other by remote copy with no copying therebetween.

13. In a computer system which includes a first datacenter having at least one computer device connected to at least one storage device via a first datacenter network, the at least one storage device including a first source volume; and a second datacenter having at least one computer device connected to at least one storage device via a second datacenter network, the at least one storage device including a second source volume, the first datacenter and the second datacenter being connected via a network, the first source volume of the first datacenter and the second source volume of the second datacenter having identical source objects; a method of establishing copyless remote copy, comprising:
ordering the first datacenter to replicate the source object in the first source volume to a first target volume;
ordering the second datacenter to replicate the source object in the second source volume to a second target volume; and
establishing remote copy with no copying between a first replicated object in the first target volume of the first datacenter and a second replicated object in the second target volume of the second datacenter.

14. A method according to claim 13, further comprising relating the source object in the first source volume of the first datacenter and the source object in the second source volume of the second datacenter by remote copy at SPLIT status.

15. A method according to claim 13, further comprising relating the first replicated object in the first target volume of the first datacenter and the second replicated object in the second target volume of the second datacenter by remote copy at PAIR with NOCOPY status.

16. A method according to claim 13, further comprising, prior to the ordering and the establishing, instructing the first datacenter and the second datacenter to install and upgrade the identical source objects, which are virtualized source objects, simultaneously in the first source volume of the first datacenter and the second source volume of the second datacenter.

17. A method according to claim 13, further comprising, prior to the ordering and the establishing, instructing the first datacenter and the second datacenter to install the source object, which is a virtualized source object, in the first source volume of the first datacenter and then to replicate the installed source object from the first source volume of the first datacenter to the second source volume of the second datacenter, and to upgrade the source object in the first source volume of the first datacenter and then to replicate the upgraded source object from the first source volume of the first datacenter to the second source volume of the second datacenter.

18. A method according to claim 13, further comprising, prior to the ordering and the establishing, instructing the first datacenter and the second datacenter to install the identical source objects, which are virtualized source objects, and to upgrade the installed objects so as not to overwrite the installed objects with the upgraded objects.

19. A method according to claim 13, further comprising, prior to the establishing, calculating hash values of the first target volume of the first datacenter and the second target volume of the second datacenter, and comparing the hash values to ascertain that the first target volume and the second target volume have the same objects.

20. A method according to claim 13,
wherein the computer system includes at least one additional datacenter each having at least one computer device connected to at least one storage device via an additional datacenter network, the at least one storage device including an additional source volume;
wherein the first datacenter, the second datacenter, and the at least one additional datacenter are connected via the network;
wherein the first source volume of the first datacenter and the additional source volume of each of the at least one additional datacenter have identical source objects;
wherein the method further comprises:
ordering each of the at least one additional datacenter to replicate the source object in the additional volume to an additional target volume; and
establishing remote copy with no copying between the first replicated object in the first target volume of the first datacenter and an additional replicated object in the additional target volume of each of the at least one additional datacenter.
